(19) United States
(12) Patent Application Publication
(10) Pub. No.: US 2012/0037725 A1
(43) Pub. Date: Feb. 16, 2012

(54) SPRINKLER CONTROL SYSTEMS AND METHODS

(75) Inventor: Neal R. Verfuerth, Manitowoc, WI (US)

(73) Assignee: Orion Energy Systems, Inc.

(21) Appl. No.: 13/223,149

(22) Filed: Aug. 31, 2011

Related U.S. Application Data
(63) Continuation-in-part of application No. 12/550,270, filed on Aug. 28, 2009.
Application No. 12/550,270 is a continuation-in-part of application No. 12/240,805, filed on Sep. 29, 2008.
Application No. 12/240,805 is a continuation-in-part of application No. 12/057,217, filed on Mar. 27, 2008.
Application No. 12/057,217 is a continuation-in-part of application No. 12/875,930, filed on Sep. 3, 2010.
(60) Provisional application No. 61/380,173, filed on Sep. 3, 2010.
(60) Provisional application No. 61/275,985, filed on Sep. 4, 2009.

(51) Int. Cl. B05B 15/00

(52) U.S. Cl. 239/289

(57) ABSTRACT

A system for controlling a sprinkler system includes an outdoor light including a control circuit and a first radio frequency transceiver. The system further includes a sprinkler zone controller having a second radio frequency transceiver and electronics for controlling at least one hydraulic valve of the sprinkler zone. The control circuit for the outdoor light is configured to provide a control signal to the sprinkler zone controller via the first radio frequency transceiver and the second radio frequency transceiver.

### CROSS-REFERENCE TO RELATED PATENT APPLICATIONS

This application claims the benefit of priority under 35 U.S.C. §119(e) of U.S. Provisional Application No. 61/380,173, filed on Sep. 3, 2010, and titled “Sprinkler Control Systems and Methods.” This application also claims the benefit of priority as a Continuation-In-Part of U.S. application Ser. No. 12/875,930, filed on Sep. 3, 2010, which claims the benefit of priority of U.S. application No. 61/275,985, filed on Sep. 4, 2009. This application also claims the benefit of priority as a Continuation-In-Part of U.S. application Ser. No. 12/550,270, filed on Aug. 28, 2009, which is a Continuation-In-Part of application Ser. No. 11/771,317, filed Jun. 29, 2007, and is also a Continuation-In-Part of U.S. Ser. No. 12/240,805, filed on Sep. 29, 2008, which is a Continuation-In-Part of U.S. application Ser. No. 12/057,217, filed Mar. 27, 2008. The subject matter of Application Nos. 61/380,128, 61/275,985, Ser. Nos. 12/875,930, 12/550,270, 12/240,805, 12/057,217, and 11/771,317 are hereby incorporated herein by reference in their entirety.

### BACKGROUND

The present invention relates generally to the field of sprinkler systems. The present invention more particularly relates to the field of sprinkler control systems and methods.

Sprinkler systems owned by a large organization (e.g., university, business campus, resort, golf course, municipality, farm, etc.) are often controlled by timers. These timers typically cause one or more electronically controlled valves to actuate, delivering fluid flow to a fluid delivery system spanning a wide area and having a plurality of distributed sprinkler heads. The timers are conventionally rigid in their application. For example, a timer may cause a sprinkler system valve to actuate at the same times every day. It may be difficult to temporarily override the timer. Even if a sprinkler system is capable of overrides or rapid reprogramming, conventional sprinkler systems are reliant on human intelligence, human overrides, human reprogramming, and the like. Yet further, sprinkler systems conventionally must be carefully planned in advance because different “zones” of sprinklers are difficult or impossible to change without installing another valve or manually changing a valve's location within the fluid delivery system. What is needed are systems and methods to allow for greater programmability, computerized intelligence, and flexibility in sprinkler system management.

### SUMMARY

One embodiment of the invention relates to a system for controlling a sprinkler system. The system includes an outdoor light having a control circuit and a first radio frequency transceiver. The system further includes a sprinkler zone controller having a second radio frequency transceiver and electronics for controlling at least one flow control device of the sprinkler zone. The control circuit for the outdoor light is configured to provide a control signal to the sprinkler zone controller via the first radio frequency transceiver and the second radio frequency transceiver. The control circuit of the outdoor light may be configured to identify sprinkler information in data received at the first radio frequency transceiver and is configured to retransmit the identified sprinkler information via the first radio frequency transceiver as the control signal. Further, the sprinkler zone controller may be configured to retransmit the control signal for other sprinkler controllers in response to receiving the control signal at the second radio frequency transceiver. The flow control devices may be, for example, valves, pumps, or a combination of valves and pumps.

Another embodiment of the invention relates to a sprinkler zone controller. The sprinkler zone controller includes an interface for providing control signals to a plurality of valves. The sprinkler zone controller further includes a control circuit and a radio frequency transceiver configured to receive a control signal from a remote source and to retransmit the control signal for reception by other sprinkler zone controllers.

Yet another embodiment of the invention relates to a sprinkler system. The sprinkler system includes a plurality of electronically controlled valves. The sprinkler system further includes a control circuit coupled to each of the plurality of electronically controlled valves, each control circuit including a radio frequency transceiver for sending and receiving data communications. The sprinkler system further includes a master controller configured to cause the plurality of electronically controlled valves to controllably actuate by transmitting a command to at least one of the plurality of electronically controlled valves.

Another embodiment of the invention relates to a device for controlling an electronically controlled sprinkler valve. The device includes a control circuit electrically coupled to the electronically controlled sprinkler valve, and configured to cause the valve to open and close. The device further includes a radio frequency transceiver configured to receive a command from a first remote source and to provide a signal to the control circuit based on the command. The control circuit is configured to cause the electronically controlled sprinkler valve to open and close based on the signal. The transceiver is further configured to rebroadcast the received command for receipt and processing by a second remote source.

Another embodiment of the invention relates to a sprinkler head. The sprinkler head includes an electronically controllable valve configured to cause the sprinkler head to controllably release and restrain fluid flow. The sprinkler head further includes a radio frequency transceiver configured to receive a command from a first remote source and to provide the command to the control circuit. The sprinkler head yet further includes a control circuit configured to provide a signal to the electronically controllable valve in response to the command.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1A is a bottom perspective view of an outdoor lighting fixture, according to an exemplary embodiment;

FIG. 1B is a illustration of a sprinkler control system 100, according to an exemplary embodiment;

FIG. 2A is a block diagram of a portion of sprinkler control system 100, according to an exemplary embodiment;

FIG. 2B is another block diagram of a portion of sprinkler control system 100, according to an exemplary embodiment;

FIG. 3A is a detailed block diagram of a sprinkler node 111 of sprinkler control system 100, according to an exemplary embodiment;

FIG. 3B is a diagram of a wirelessly controllable sprinkler node serving as a zone controller within a larger sprinkler control system, according to an exemplary embodiment;

FIG. 4A is a diagram of a sprinkler system having a wirelessly controllable sprinkler system master controller, according to an exemplary embodiment;

FIG. 4B is a block diagram of sprinkler system master controller such as sprinkler system master controller 404 shown in FIG. 4B, according to an exemplary embodiment;

FIG. 5A is a diagram of a sprinkler system having wirelessly controllable electronic valves, according to an exemplary embodiment;

FIG. 5B is a detailed block diagram of wirelessly controllable electronic valve 510 shown in FIG. 5A, according to an exemplary embodiment;

FIG. 6A is a diagram of a sprinkler control system having wirelessly controllable sprinkler heads, according to an exemplary embodiment;

FIG. 6B is a diagram of wirelessly controllable sprinkler head 612 shown in FIG. 6A, according to an exemplary embodiment;

FIG. 7 is a detailed block diagram of control computer 202 shown in previous Figures, according to an exemplary embodiment; and

FIG. 8 is a block diagram of a system for managing wirelessly-enabled assets, according to an exemplary embodiment.

### DETAILED DESCRIPTION

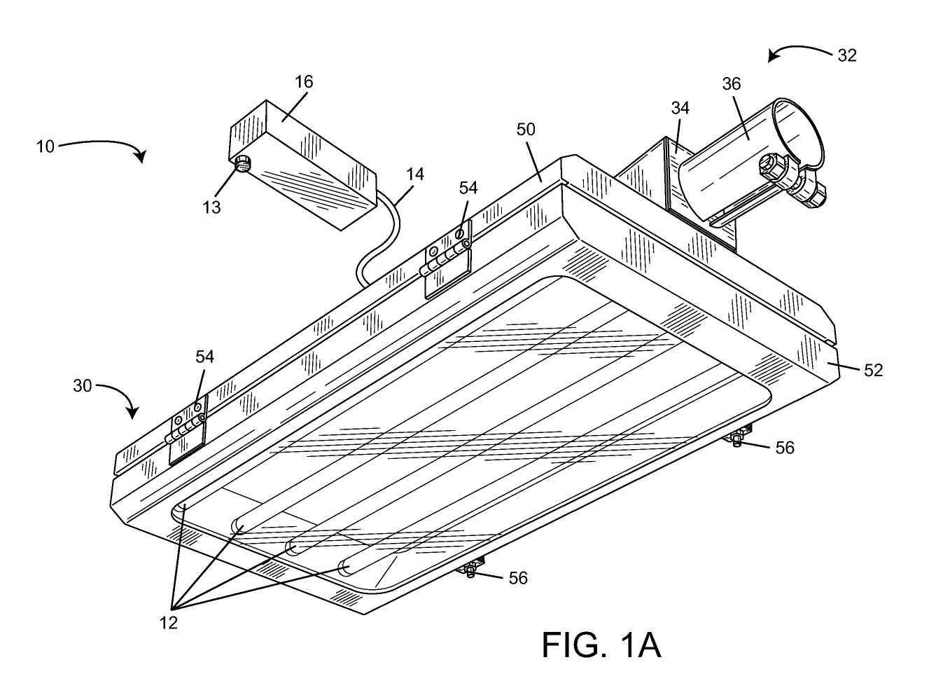

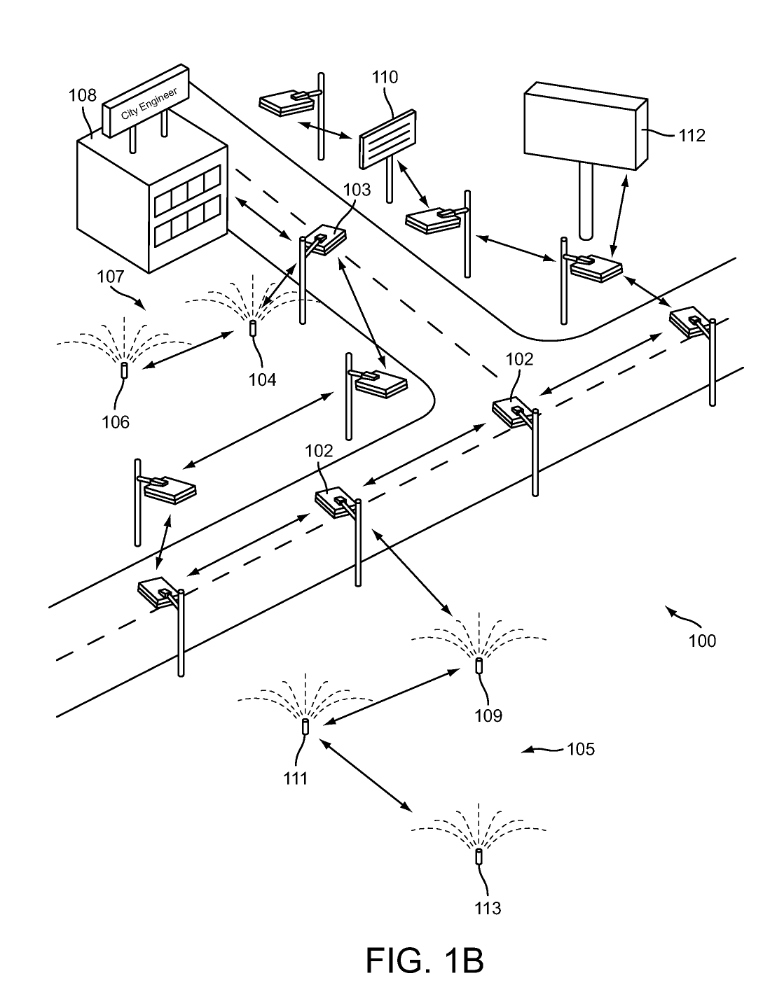

Referring generally to the Figures, sprinkler control systems and methods are shown. The control systems generally include radio frequency transceivers for wireless transmission of sprinkler information. In some embodiments the sprinkler control systems are wirelessly integrated with lighting systems to provide for networks of controllable devices. For example, embodiments of the sprinkler control systems can include an outdoor fluorescent lighting fixture such as outdoor lighting fixture 10 shown in FIG. 1A.

FIG. 1A is a bottom perspective view of outdoor fluorescent lighting fixture system 10, according to an exemplary embodiment. Outdoor fluorescent lighting fixture 10 is configured for applications such as a street lighting application or a parking lot lighting application. In some embodiments, outdoor fluorescent lighting fixture 10 is configured for coupling to high poles or masts. Outdoor fluorescent lighting fixture 10 may also be configured to provide wired or wireless communications capabilities, one or more control algorithms (e.g., based on sensor feedback, received wireless commands or wireless messages, etc.), built-in redundancy, and venting. Outdoor lighting fixture 10 is configured to route sprinkler commands to sprinkler nodes (e.g., sprinkler heads, sprinkler valve controls, etc.).

In FIG. 1A, outdoor lighting fixture 10 is configured for coupling to a pole and for directing toward the ground. Such an orientation may be used to illuminate streets, sidewalks, bridges, parking lots, and other outdoor areas where ground illumination is desirable. Outdoor lighting fixture 10 is shown to include a mounting system 32 and a housing 30. Mounting system 32 is configured to mount fixture 10 including housing 30 to a pole or mast. In an exemplary embodiment, housing 30 surrounds one or more fluorescent lamps 12 (e.g., fluorescent tubes) and includes a lens (e.g., a plastic sheet, a glass sheet, etc.) that allows light from fluorescent lamps 12 to be provided from housing 30.

Mounting system 32 is shown to include a mount 34 and a compression sleeve 36. Compression sleeve 36 is configured to receive the pole and to tighten around the pole (e.g., when a clamp is closed, when a bolt is tightened, etc.). Compression sleeve 36 may be sized and shaped for attachment to existing outdoor poles such as street light poles, sidewalk poles, parking lot poles, and the like. As is provided by mounting system 32, the coupling mechanism may be mechanically adaptable to different poles or masts. For example, compression sleeve 36 may include a taper or a tapered cut so that compression sleeve 36 need not match the exact diameter of the pole or mast to which it will be coupled. While lighting fixture 10 shown in FIG. 1A utilizes a compression sleeve 36 for the mechanism for coupling the mounting system to a pole or mast, other coupling mechanisms may alternatively be used (e.g., a two-piece clamp, one or more arms that bolt to the pole, etc.).

According to an exemplary embodiment, fixture 10 and housing 30 are elongated and mount 34 extends along the length of housing 30. Mount 34 is preferably secured to housing 30 in at least one location beyond a lengthwise center point and at least one location before the lengthwise center point. In other exemplary embodiments, the axis of compression sleeve 36 also extends along the length of housing 30. In the embodiment shown in FIG. 1A, compression sleeve 36 is coupled to one end of mount 34 near a lengthwise end of housing 30.

Housing 30 is shown to include a fixture pan 50 and a door frame 52 that mates with fixture pan 50. In the embodiments shown in the Figures, door frame 52 is mounted to fixture pan 50 via hinges 54 and latches 56. When latches 56 are released, door frame 52 swings away from fixture pan 50 to allow access to the fluorescent bulbs within housing 30. Latches 56 are shown as compression-type latches, although many alternative locking or latching mechanisms may be alternatively or additionally provided to secure the different sections of the housing. In some embodiments the latches may be similar to those found on “NEMA 4” type junction boxes or other closures. Further, many different hinge mechanisms may be used. Yet further, in some embodiments door frame 52 and fixture pan 50 may not be joined by a hinge and may be secured together via latches 56 on all sides, any number of screws, bolts or other fasteners that do not allow hinging, or the like. In an exemplary embodiment, fixture pan 50 and door frame 52 are configured to sandwich a rubber gasket that provides some sealing of the interior of housing 30 from the outside environment. In some embodiments the entirety of the interior of lighting fixture 10 is sealed such that rain and other environmental moisture does not easily enter housing 30. Housing 30 and its component pieces may be galvanized steel but may be any other metal (e.g., aluminum), plastic, and/or composite material. Housing 30, mounting system 32 and/or the other metal structures of lighting fixture 10 may be powder coated or otherwise treated for durability of the metal. According to an exemplary embodiment housing 30 is powder coated on the interior and exterior surfaces to provide a hard, relatively abrasion resistant, and tough surface finish.

Housing 30, mounting system 32, compression sleeve 36, and the entirety of lighting fixture 10 are preferably extremely robust and able to withstand environmental abuses of outdoor lighting fixtures. The shape of housing 30 and mounting system 32 are preferably such that the effective projection area (EPA) relative to strong horizontal winds is minimized—which correspondingly provides for minimized wind loading parameters of the lighting fixture.

Ballasts, structures for holding lamps, and the lamps themselves may be installed to the interior of fixture pan 50. Further, a reflector may be installed between the lamp and the interior metal of fixture pan 50. The reflector may be of a defined geometry and coated with a white reflective thermosetting powder coating applied to the light reflecting side of the body (i.e., a side of the reflector body that faces toward a fluorescent light bulb). The white reflective coating may have reflective properties, which in combination with the defined geometry of the reflector, provides high reflectivity. The reflective coating may be as described in U.S. Prov. Pat. App. No. 61/165,397, filed Mar. 31, 2009. In other exemplary embodiments, different reflector geometries may be used and the reflector may be uncoated or coated with other coating materials. In yet other embodiments, the reflector may be a “MIRO 4” type reflector manufactured and sold by Alanod GmbH & Co KG.

The shape and orientation of housing 30 relative to the reflector and/or the lamps is configured to provide a full cut off such that light does not project above the plane of fixture pan 50. The lighting fixtures described herein are preferably “dark-sky” compliant or friendly.

To provide further resistance to environmental variables such as moisture, housing 30 may include one or more vents configured to allow moisture and air to escape housing 30 while not allowing moisture to enter housing 30. Moisture may enter enclosed lighting fixtures due to vacuums that can form during hot/cold cycling of the lamps. According to an exemplary embodiment, the vents include, are covered by, or are in front of one or more pieces of material that provide oleophobic and hydrophobic protection from water, washing products, dirt, dust and other air contaminants. According to an exemplary embodiment the vents may include GORE membrane sold and manufactured by W.L. Gore & Associates, Inc. The vent may include a hole in the body of housing 30 that is plugged with a snap-fit (or otherwise fit) plug including an expanded polytetrafluoroethylene (ePTFE) membrane with a polyester non-woven backing material.

Referring still to FIG. 1A, lighting fixture 10 is shown to include a housing 30 (e.g., frame, fixture pan, etc.) within which fluorescent lamps 12 are housed. While various Figures of the present disclosure, including FIG. 1A, illustrate lighting fixtures for fluorescent lamps, it should be noted that embodiments of the present application may be utilized with any type of lighting fixture and/or lamps. Further, while housing 30 is shown as being fully enclosed (e.g., having a door and window covering the underside of the fixture), it should be noted that any variety of lighting fixture shapes, styles, or types may be utilized with embodiments of the present disclosure. Further, while controller 16 is shown as having a housing that is exterior to housing 30 of lighting fixture 10, it should be appreciated that controller 16 may be physically integrated with housing 30. For example, one or more circuit boards or circuit elements of controller 16 may be housed within, on top of, or otherwise secured to housing 30. Further, in other exemplary embodiments, controller 16 (including its housing) may be coupled directly to housing 30. For example, controller 16's housing may be latched, bolted, clipped, or otherwise coupled to the interior or exterior of housing 30. Controller 16's housing may generally be shaped as a rectangle (as shown), may include one or more non-right angles or curves, or otherwise configured. In an exemplary embodiment, controller 16's housing is made of plastic and housing 30 for lighting fixture 10 is made from metal. In other embodiments, other suitable materials may be used.

Controller 16 is connected to lighting fixture 10 via wire 14. Controller 16 is configured to control the switching between different states of lighting fixture 10 (e.g., all lamps on, all lamps off, some lamps on, etc.).

According to various embodiments, controller 16 is further configured to log usage information for lighting fixture 10 in a memory device local to controller 16. Controller 16 may further be configured to use the logged usage information to affect control logic of controller 16. Controller 16 may also or alternatively be configured to provide the logged usage information to another device for processing, storage, or display. Controller 16 is shown to include a sensor 13 coupled to controller 16 (e.g., controller 16's exterior housing). Controller 16 may be configured to use signals received from sensor 13 to affect control logic of controller 16. Further, controller 16 may be configured to provide information relating to sensor 13 to another device.

Referring to FIG. 1B, a diagram of a sprinkler control system 100 is shown, according to an exemplary embodiment. Sprinkler control system 100 includes a plurality of outdoor lights 102 (e.g., shown as street lights but could be parking lot lights, walkway lights, etc.). Some or all of outdoor lights 102 include radio frequency transceivers configured for wireless data transmission.

Outdoor lights 102 include control circuits that are configured to use their radio frequency transceivers to communicate with each other and with one or more master controllers (e.g., located at a city engineer's office, department of public works, etc.). For example, such a master controller may be configured to turn a particular street light or street light zone on or off by sending a command to an outdoor light 103 within a relatively short broadcast range of the city engineer's office. Outdoor light 103 can rebroadcast the command to nearby lights which can in turn rebroadcast or route the command throughout the network created by the outdoor lights and their radio frequency transceivers. When the appropriate outdoor light of the system receives the command, the outdoor light uses control logic to turn on or off in response to the command.

In addition to commands and information for outdoor lights, the wireless network of outdoor lights can send and receive sprinkler information via the radio frequency transceivers. With reference to FIG. 1B, a master controller at city engineer's office 108 may be configured to broadcast a sprinkler command to nearby outdoor light 103. Outdoor lights 102 can receive, interpret, and rebroadcast the sprinkler command throughout the outdoor lighting network. Sprinkler nodes (e.g., valve controllers, sprinkler heads, sprinkler zone controllers, etc.) nearby a broadcasting outdoor light 102 or another broadcasting source (e.g., a transmitter associated with city engineer's office 108, a transmitter coupled to a street sign 110, a transmitter coupled to a billboard 112, etc.) can receive the rebroadcast sprinkler commands, process the commands for action, and/or rebroadcast the commands for other nearby sprinkler nodes. For example, a sprinkler command intended for sprinkler zone 105 may propagate from city engineer's office 108 to a first sprinkler node 109 via nearby outdoor light 103 and outdoor lights 102. First sprinkler node 109 may process and respond to the sprinkler command (e.g., by opening a valve and beginning to deliver water to the nearby lawn or foliage). First sprinkler node 109 may also forward or broadcast the sprinkler command to the other sprinkler nodes in zone 105 (i.e., sprinkler nodes 111 and 113). A sprinkler command originating from city engineer's office 108 or another source may include a zone designator such that a “sprinkler on” command that is transmitted through system 100 is only acted upon by the proper zone. For example, a sprinkler command including a zone designator representative of zone 105 will not be acted upon by zone 107, even if nodes 104, 106 of zone 107 receive such the sprinkler command. The sprinkler nodes of zone 107, however, may be configured to rebroadcast the received sprinkler command even though (or particularly because) the sprinkler command includes a zone designator for another zone.

In some exemplary embodiments, the sprinkler nodes are routing nodes that form an integral part of a wide area municipal communications network. For example, commands and data for many different types or parts of municipal devices (e.g., street sign 110, billboard 112, etc.) may travel through sprinkler nodes 104, 106, 109, 111, 113, etc., configured to route information through the network.

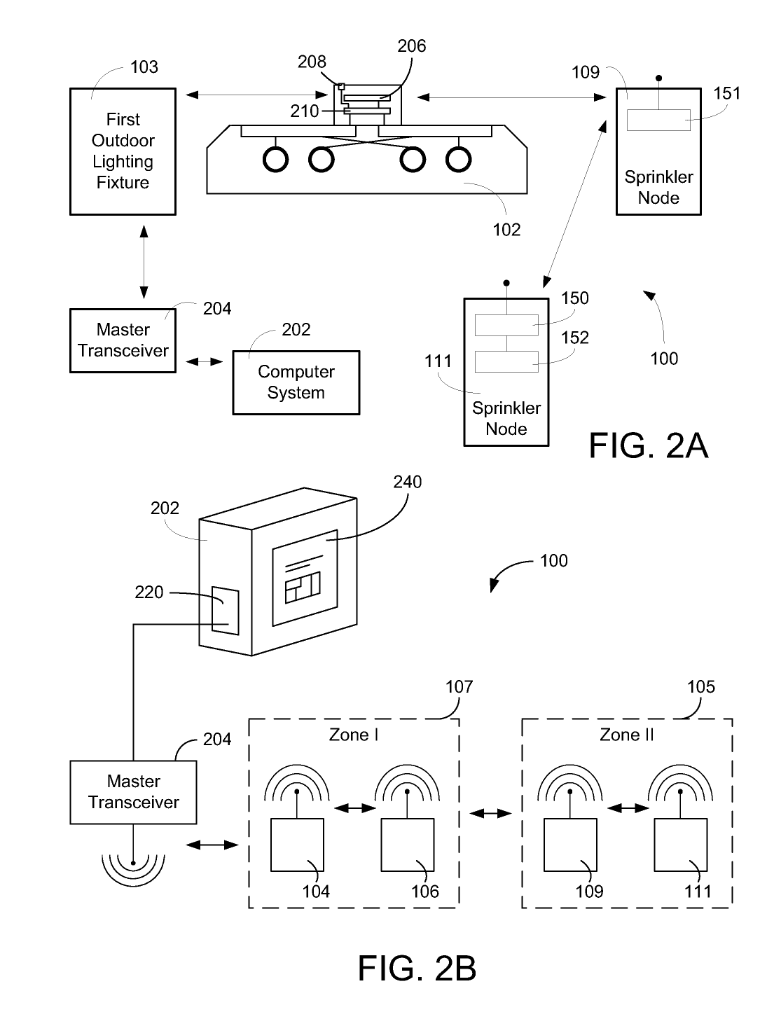

Referring now to FIG. 2A, a simplified diagram of a portion of sprinkler control system 100 is shown, according to an exemplary embodiment. Computer system 202 sends and receives data to and from first outdoor light 103 via master transceiver 204. For example, computer system 202 may receive sensor information (e.g., motion sensor information) from first outdoor light 103 and determine a mode of operation for sprinkler nodes 109, 111 and first outdoor light 103 based on the sensor information and/or other information (e.g., time information, scheduling information, environment information, energy usage information, etc.).

Sprinkler nodes 109, 111 may be outside of the range of first outdoor light 103. Accordingly, when first outdoor light 103 receives a sprinkler command addressed for sprinkler node 111, first outdoor light 103 will rebroadcast the sprinkler command for reception by outdoor lighting fixture 102 that is within the transmission range of first outdoor light 103. Outdoor lighting fixture 102 receives the sprinkler command at radio frequency transceiver 206 and rebroadcasts the sprinkler command to a nearby sprinkler node 109. Sprinkler node 109 has a radio frequency transceiver 151 of its own that receives the sprinkler command from outdoor lighting fixture 102 and rebroadcasts the sprinkler command to destination sprinkler node 111. In an exemplary embodiment, sprinkler node 111 includes a sprinkler control circuit 152 that interprets the received sprinkler command and takes a control action to change states (e.g., activates a valve to begin the flow of water for sprinkling) based on the interpreted sprinkler command. Once sprinkler control circuit 152 takes the control action, sprinkler control circuit 152 may cause its radio frequency transceiver 150 to transmit an acknowledgment that the reception and subsequent action were successful. Sprinkler control circuit 152 can address the acknowledgement for computer system 202 or master transceiver 204. Sprinkler node 109, upon receiving the acknowledgement and determining that the acknowledgment is for computer system 202 or master transceiver 204, may then rebroadcast the acknowledgement for traversal through the network comprised of sprinkler nodes and outdoor lighting fixtures back to first outdoor lighting fixture 103, master transceiver 204, and computer system 202.

While sprinkler nodes 109, 111 can receive commands primarily from computer system 202 and master transceiver 204, sprinkler nodes 109, 111 may also receive commands from nearby outdoor lighting fixtures 102. In yet other embodiments or situations, sprinkler nodes 109, 111 may include logic within their own sprinkler control circuits (e.g., sprinkler control circuit 152) for operating relatively independently. Such a sprinkler control circuit 152 may use information received at radio frequency transceiver 150 to determine when to change sprinkler states or, for example, when to delay a sprinkler cycle. A motion sensor 208 coupled to outdoor lighting fixture 102 and to outdoor lighting fixture's control circuit 210 may be configured to sense motion (e.g., by people or vehicles in the area, etc.). Control circuit 210 may then be configured to send an indication of the motion to sprinkler nodes 109, 111 via radio frequency transceiver 206. The indication of the motion transmitted to sprinkler nodes 109, 111 may be transmitted in a data message including a location identifier of outdoor lighting fixture 102. In other embodiments the indication of the motion transmitted to sprinkler nodes 109, 111 may be transmitted without a location identifier, the receiving sprinkler nodes 109, 111 acting relative to any motion indication transmitted within range for the sprinkler nodes' to receive. In yet other embodiments, outdoor lighting fixture 102 addresses the indication of motion particularly for sprinkler node 109 or sprinkler node 111. In still other embodiments outdoor lighting fixture 102 includes a zone identifier with its motion indication transmission and the sprinkler nodes that receive the zone identifier are configured to compare the received zone identifier to stored zone identifiers. If the received zone identifier matches the sprinkler node's zone identifier, sprinkler control circuit 152 is configured to take action based on the zone match and the rest of the message's contents. Accordingly, a sprinkler control system 100 may be provided wherein the sprinkler nodes are organized in zones and are controllable by one or more outdoor lighting fixtures nearby each zone.

The concept of sprinkler zones is described in greater detail in FIG. 2B. In FIG. 2B, another diagram of sprinkler system 100 is shown, according to an exemplary embodiment. Control computer 202 may be configured to conduct or coordinate control activities relative to multiple sprinkler zones 107, 105. Control computer 202 is preferably configured to provide a graphical user interface to a local or remote electronic display screen for allowing a user to adjust control parameters, turn sprinkler valves on or off, or to otherwise affect the operation of sprinklers in a facility.

In the example shown in FIG. 2B, control computer 202 is shown to include a touch screen display 240 for displaying such a graphical user interface for controlling varying sprinkler zones 105, 107 and for allowing user interaction (e.g., input and output) with control computer 202. It should be noted that while control computer 202 is shown in FIG. 2B as housed in a wall-mounted panel it may be housed in or coupled to any other suitable computer casing or frame. The user interfaces are intended to provide an easily configurable sprinkler system for a facility. The user interfaces are intended to allow even untrained users to reconfigure or reset a sprinkler system using relatively few clicks. In an exemplary embodiment, the user interfaces do not require a keyboard for entering values. Advantageously, users other than city engineers or managers may be able to setup, interact with, or reconfigure the system using the provided user interfaces.

Referring further to FIG. 2B, control computer 202 is shown as connected to master transceiver 204. Master transceiver 204 includes a radio frequency transceiver configured to provide wireless signals to a network of outdoor lighting fixtures and/or a network of sprinkler nodes (e.g., sprinkler nodes 104, 106, 109, 111). In FIG. 2B, master transceiver 204 is shown in bi-directional wireless communication with a plurality of sprinkler zones 105, 107. FIG. 2B further illustrates sprinkler nodes 104 and 106 forming a first logical group 107 identified as “Zone I” and sprinkler nodes 109 and 111 forming a second logical group 105 identified as “Zone II.” Control computer 202 may be configured to provide different processing or different commands for zone 107 relative to zone 105. While control computer 202 is configured to complete a variety of control activities for sprinkler nodes 104, 106, 109, 111, in many exemplary embodiments of the present disclosure, each sprinkler node (e.g., 104, 106, 109, 111) includes a sprinkler control circuit (e.g., circuit 152 shown in FIG. 2A) configured to provide a variety of “smart” or “intelligent features” that are either independent of control computer 202 or operate in concert with control computer 202.

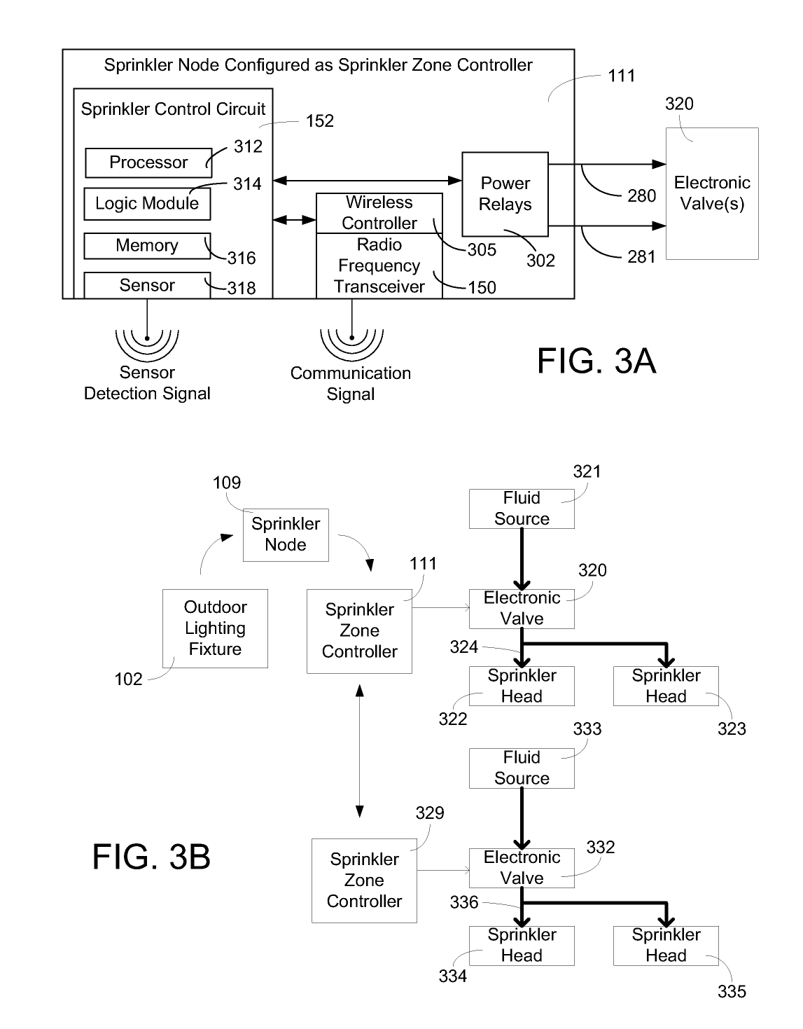

Referring now to FIG. 3A, a detailed block diagram of sprinkler node 111 is shown, according to an exemplary embodiment. Sprinkler node 111 may be considered a “sprinkler zone controller” configured to control one or more electronic valves 320 that affect the flow of fluid through a sprinkler zone.

FIG. 3B illustrates sprinkler node 111 serving as a zone controller within a larger sprinkler control system. Outdoor lighting fixture 102 relays sprinkler commands or sprinkler messages (via sprinkler node 109) to sprinkler zone controller 111 for interpretation and action. In response to such sprinkler commands, if sprinkler zone controller 111 determines that the commands are for the proper zone, sprinkler zone controller 111 can cause an electronically controlled valve 320 to which it is coupled to open or close. Electronic valve 320 can receive fluid from a fluid source 321 (e.g., a municipal water source) and provide the fluid to a hydraulic network 324 when the electronic valve is in an open position. When sprinkler zone controller 111 directly controls an electronic valve 320 that provides or restricts fluid flow to sprinkler heads 322, 323, the sprinkler heads may not include any control logic. For example, the sprinkler heads 322, 323 may be relatively simple sprinkler heads that pop up and project water for sprinkling based simply on the fluid pressure. In other embodiments, some of which are described in detail, sprinkler heads 322, 323 can include control circuits of their own for communication with a sprinkler control system and/or for control of a local valve. In FIG. 3B, sprinkler zone controller 111 is shown in wireless communication with another sprinkler zone controller 329. Sprinkler zone controller 329 may be a member of a different zone than sprinkler zone controller 111 and messages from a control computer may be routed to sprinkler zone controller 329 via sprinkler zone controller 111 and/or outdoor lighting fixture 102. In other embodiments sprinkler zone controller 329 is in the same zone as sprinkler zone controller 111 but controls sprinkler heads 334, 335 for other areas of the zone via actuation of electronic valve 332. When electronic valve 332 is open it provides fluid from fluid source 333 to sprinkler heads 334, 335 via hydraulic network 336.

Referring again to FIG. 3A, sprinkler node 111 configured as a sprinkler zone controller is shown to include sprinkler control circuit 152. Sprinkler control circuit 152 includes circuitry configured to complete the activities of sprinkler node 111 described herein. For example, sprinkler control circuit 152 may be configured with control logic for controllably providing power to power relays 302 and electronic valve(s) 320. Sprinkler control circuit 152 may further include control logic for preventing rapid on/off cycling of connected sprinkler valves, an algorithm to log usage information for electronic valve(s) 320, an algorithm configured to limit wear on electronic valve(s) 320, and an algorithm configured to allow sprinkler node 111 to send and receive commands or information from other peer devices independently from a master controller or master transceiver. Sprinkler control circuit 152 includes processor 312, logic module 314, and memory 316.

Sprinkler node 111 is shown to include power relays 302 configured to controllably switch on or off power outputs that may be provided to electronic valves 320 via wires 280, 281. It should be noted that in other exemplary embodiments, power relays 302 may be configured to provide a signal other than a power output (e.g., an optical signal) to electronic valves 320 which may cause one or more of valves 320 to turn on and off. Sprinkler node 111 may include a port, terminal, receiver, or other input for receiving power (e.g., from a battery, from a panel, from a power grid, etc.). In any embodiment of sprinkler node 111, appropriate power supply circuitry (e.g., filtering circuitry, stabilizing circuitry, etc.) may be included with sprinkler node 111 to controllably provide power to the components of sprinkler node 111 (e.g., relays 302).

Referring still to FIG. 3A, sprinkler control circuit 152 receives and provides data or control signals from/to power relays 302 and radio frequency transceiver 150 via wireless controller 305. Sprinkler control circuit 152 is configured to cause one or more valves of the sprinkler system to turn on and off via control signals sent to power relays 302. Control circuit 152 can make a determination that an “on” or “off” signal should be sent to power relays 302 based on inputs received from wireless controller 305. For example, a command to turn an electronic valve “off” may be received at wireless transceiver 150 and interpreted by wireless controller 305 and sprinkler control circuit 152. Upon recognizing the “off” command, sprinkler control circuit 152 then appropriately switches one or more of power relays 302 off Similarly, when circuit 152 including sensor 318 experiences an environmental condition, logic module 314 may determine whether or not the controller and sprinkler control circuit 152 should change “on/off” states. For example, if motion is detected by sensor 318, logic module 314 may determine to change states such that power relays 302 are “off.” Conversely, if motion is not detected by sensor 318 for a predetermined period of time, logic module 314 may cause sprinkler control circuit 152 to turn power relays 302 “on.” Other control decisions, logic and activities provided by node 111 and the components thereof are described below and with reference to other Figures.

When or after control decisions based on sensor 318 or commands received at radio frequency transceiver 150 are made, in some exemplary embodiments, logic module 314 is configured to log usage information for sprinkler node 111 in memory 316. For example, if sprinkler control circuit 152 causes power relays 302 to change states such that one or more electronic valves 320 turn on or off, sprinkler control circuit 152 may inform logic module 314 of the state change and logic module 314 may log usage information based on the information from sprinkler control circuit 152. The form of the logged usage information can vary for different embodiments. For example, in some embodiments, the logged usage information includes an event identifier (e.g., “on”, “off”, cause for the state change, etc.) and a timestamp (e.g., day and time) from which total usage may be derived. In other embodiments, the total “on” time for a sprinkler valve (or a zone of sprinkler valves) is counted such that only an absolute number of hours that the valve has been on (for whatever reason) has been tracked and stored as the logged usage information. In addition to logging or aggregating temporal values, each logic module 314 may be configured to process usage information or transform usage information into other values or information. For example, in some embodiments time-of-use information is transformed by logic module 314 to track the water used by the sprinkler zone that sprinkler node 111 controls (e.g., based on known fluid flow rates allowed through the valve in an “on” mode, etc.). In some embodiments, each logic module 314 will also track how much energy savings the sprinkler system is achieving relative to a conventional sprinkler system, conventional control logic, or relative to another difference or change of the sprinkler system. For the purposes of many embodiments of this disclosure, any information relating to usage for the valves of the sprinkler system may be considered logged “usage information.” In some embodiments, the usage information logged by module 314 is limited to on/off events or temporal aggregation of on states and does not include fluid savings information or total-fluid-used numbers. In any embodiments more complete calculations may be completed by a control computer 202 or another remote device after receiving usage information from sprinkler node 111.

In an exemplary embodiment, sprinkler control circuit 152 (e.g., via radio frequency transceiver 150 and wireless controller 305) is configured to transmit the logged usage information to remote devices such as control computer 202. Sprinkler control circuit 152 and/or wireless controller 305 may be configured to recall the logged usage information from memory 316 at periodic intervals (e.g., every hour, once a day, twice a day, etc.) and to provide the logged usage information to radio frequency transceiver 150 at the periodic intervals for transmission back to control computer 202. In other embodiments, control computer 202 (or another network device) transmits a request for the logged information to radio frequency transceiver 150 and the request is responded to by wireless controller 305 by transmitting back the logged usage information. In a preferred embodiment a plurality of sprinkler nodes such as sprinkler node 111 asynchronously collect usage information for their sprinkler zones. Control computer 202, via receipt of the usage information by the sprinkler nodes, gathers the usage information for later use.

Wireless controller 305 may be configured to handle situations or events such as transmission failures, reception failures, and the like. Wireless controller 305 may respond to such failures by, for example, operating according to a retransmission scheme or another transmit failure mitigation scheme. Wireless controller 305 may also control any other modulating, demodulating, coding, decoding, routing, or other activities of radio frequency transceiver 150. For example, control circuit 152's control logic (e.g., controlled by logic module 314) may periodically include making transmissions to other controllers in a zone, making transmissions to particular controllers, or otherwise. Such transmissions can be controlled by wireless controller 305 and such control may include, for example, maintaining a token-based transmission system, synchronizing clocks of the various RF transceivers or controllers, operating under a slot-based transmission/reception protocol, or otherwise.

Referring still to FIG. 3A, sensor 318 may be an infrared sensor, an optical sensor, a camera, a temperature sensor, a photodiode, a carbon dioxide sensor, or any other sensor configured to sense environmental conditions such as human occupancy, weather, lighting, or any other property of a space. For example, in one exemplary embodiment, sensor 318 is a motion sensor and logic module 314 is configured to determine whether control circuit 152 should change states (e.g., change the state of power relays 302) based on whether motion is detected by sensor 318 (e.g., detected motion reaches or exceeds threshold value). In the same or other embodiments, logic module 314 may be configured to use the signal from the sensor 318 to determine an ambient lighting level. Logic module 314 may then determine whether to change states based on the ambient lighting level. For example, logic module 314 may use a lighting level to determine whether to turn the electronic valve for the sprinklers off or on. If the light is too intense, even if the sprinkler is scheduled to be on, logic module 314 may refrain from turning the sprinkler on to avoid the water from the sprinkler “burning” off the plants too quickly—an undesirable condition. In another embodiment, by way of further example, logic module 314 is configured to provide a command to control circuit 152 that is configured to cause control circuit 152 to turn the sprinkler zone on to a sprinkling state when logic module 314 does not detect motion via the signal from sensor 318, when logic circuit 314 determines that the ambient lighting level is between a low threshold and a high threshold, and when logic circuit 314 determines that the current time is associated with an “allowed” time for sprinkling

Referring yet further to FIG. 3A, control circuit 152 is configured to prevent damage to valves 320 from rapid on/off cycling by holding valves 320 in an “off” state for a predefined period of time (e.g., thirty minutes, fifteen minutes, etc.) even after the condition that caused the valve to turn on is no longer true. Accordingly, if, for example, a lighting level causes control circuit 152 to turn valves 320 on but then the lighting level suddenly changes such that valves 320 should turn off, control circuit 152 may still keep valves 320 on for a predetermined period of time so that valves 320 are taken through their preferred cycle. Similarly, control circuit 152 may be configured to hold valves 320 in an “off” state for a predefined period of time since valves 320 were last turned off to ensure that the structures of the valves 320 are not undesirably “pulsed.” In other embodiments, logic module 314 or control circuit 152 may be configured to prevent rapid on/off switching due to sensed motion, another environmental condition, or a sensor or controller error. Logic module 314 or control circuit 152 may be configured to, for example, entirely discontinue the on/off switching based on inputs received from sensor 318 by analyzing the behavior of the sensor, the switching, and a logged usage information. By way of further example, logic module 314 or control circuit 152 may be configured to discontinue the on/off switching based on a determination that switching based on the inputs from sensor 318 has occurred too frequently (e.g., exceeding a threshold number of “on” switches within a predetermined amount of time, undesired switching based on the time of day or night, etc.). Logic module 314 or control circuit 152 may be configured to log or communicate such a determination. Using such configurations, logic module 314 and/or control circuit 152 are configured to self-diagnose and correct undesirable behavior that would otherwise continue occurring based on the default, user, or system-configured settings.

According to one embodiment, a self-diagnostic feature would monitor the number of times that a valve was instructed to turn on (or off) based upon a signal received from a sensor. If the number of instructions to turn on (or off) exceeded a predetermined limit during a predetermined time period, logic module 314 and/or control circuit 152 could be programmed to detect that the particular application for the valve is not well-suited to control by such a sensor, and would be programmed to disable such a motion or control scheme, and report/log this action and the basis for the action or determination. For example, if the algorithm is based on more than four instructions to turn on the sprinkling activity in a 24 hour period, and the number of instructions provided by the algorithm (e.g., based on signals from the sensor) exceeds this limit within this period, the particular sensor-based control function would be disabled as not being optimally suited to the application and a notification would be logged and provided to a user or facility manager. Of course, the limit and time period may be any suitable number and duration intended to suit the operational characteristics of the valve and the application. In the event that a particular sensor-based control scheme in a particular zone is disabled by the logic module and/or control circuit, the sprinkler system is intended to remain operational in response to other available control schemes (e.g. other sensors, time-based, user input or demand, etc.). The data logged by the logic module and/or control circuit may also be used in a ‘learning capacity’ so that the controls may be more optimally tuned in a particular application and/or zone. For example, logic module 314 and/or control circuit 154 may determine that disablement of a particular sensor-based control feature occurred due to an excessive amount of detected motion within a particular time window. Rather than turning a sprinkler on when there is expected to be pedestrian motion in an area, logic module 314 may automatically reprogram itself to establish an alternate time to begin sprinkling (e.g., one in which sensed motion is historically low). Thus, each sprinkler node may begin to ‘avoid’ sprinkling during time periods that are determined to be problematic using learning logic of logic module 314. This ability to learn or self-update is intended to permit the sprinkler system to adjust itself to update the sensor-based control schemes to different time periods that are more optimally suited for such a control scheme, and to avoid time periods that are less optimum for such a particular sensor-based control scheme.

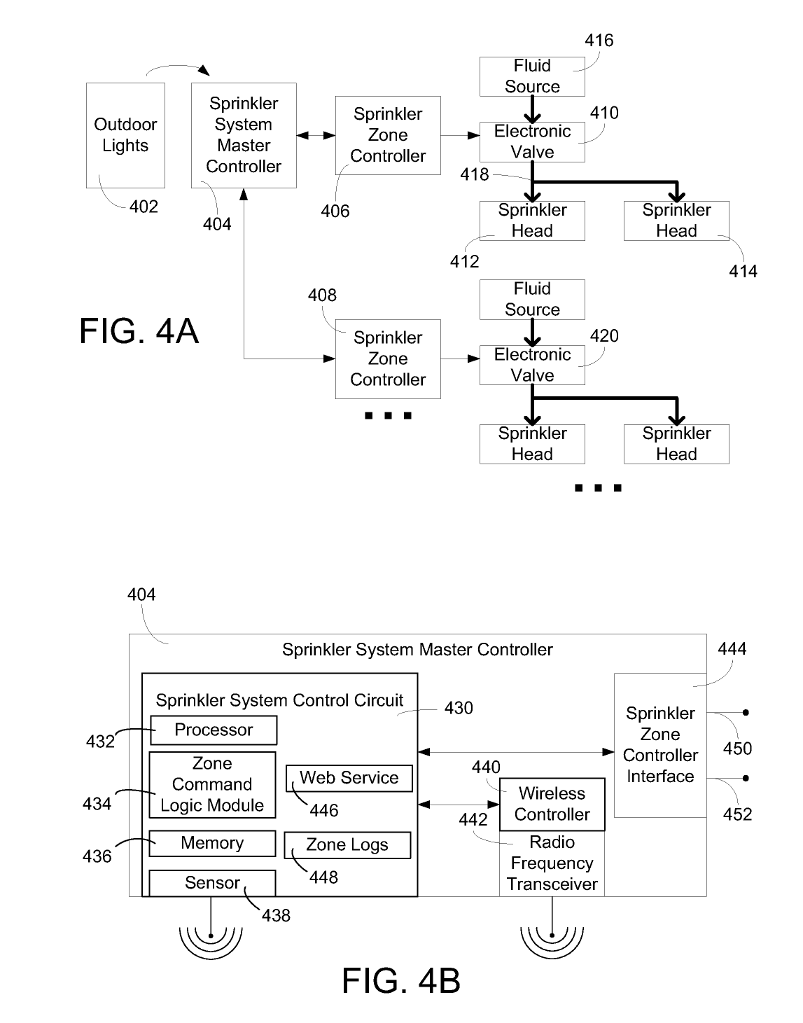

Referring now to FIG. 4A, a diagram of a sprinkler system having a wirelessly controllable sprinkler system master controllers 404 is shown, according to an exemplary embodiment. Outdoor lighting fixture 402 relays sprinkler commands, sprinkler messages, or other setting information to sprinkler system master controller 404 via radio frequency communication. In other embodiments sprinkler system master controller 404 is wired to a communications network (e.g., LAN, WAN, WLAN, Internet, etc.). Further, while sprinkler system master controller 404 is described as receiving sprinkler commands or other information from outdoor lights 402, sprinkler system master controller 404 may receive sprinkler commands from other sources (e.g., web-browsing clients, personal digital assistants within range of, e.g., a Bluetooth transceiver of the sprinkler system master controller, etc.). In yet other embodiments sprinkler system master controller 404 can include a web server or collection of web services configured to serve web-based user interfaces to devices connecting (e.g., directly, indirectly) to sprinkler system master controller 404. Sprinkler system master controller 404 may be wired or wirelessly connected to a plurality of sprinkler zone controllers 406, 408. Sprinkler zone controllers 406, 408 may be configured as described with reference to FIGS. 3A and 3B. In other embodiments sprinkler zone controllers 406, 408 are configured as “slave” devices—having relatively little control logic of their own but responding to commands from sprinkler system master controller 404. In some embodiments sprinkler zone controllers 406, 408 may be full-function sprinkler zone controllers as described with reference to FIGS. 3A and 3B, but may be selectively/electronically placed in a “slave” mode or reduced function mode of operation. Such a selection may occur via signals received from, e.g., sprinkler system master controller 404, via a mechanical switch on sprinkler zone controllers 406, 408, or otherwise. Sprinkler zone controllers 406, 408 may be configured to recognize communications intended for their zone (e.g., having an identifier matching their zone identifier, having an address particular to the receiving sprinkler zone controller, etc.). In response to an “on” sprinkler command identified with a zone identifier matching that of sprinkler zone controller 406, for example, sprinkler zone controller 406 provides a signal to electronic valve 410 that allows a fluid flow from fluid source 416 through hydraulic network 418 and to sprinkler heads 412, 414. In an exemplary embodiment sprinkler system master controller 404 may include logic that prevents sprinkler zone controller 406 and sprinkler zone controller 408 from having their electronic valves 410, 420 open at the same time. Accordingly, in parallel (or close-in-time) with the “on” sprinkler command for the sprinkler zone controller 406, sprinkler system master controller 404 may transmit an “off” sprinkler command for sprinkler zone controller 408.

Referring now to FIG. 4B, a block diagram of sprinkler system master controller 404 is shown, according to an exemplary embodiment. Sprinkler system master controller 404 is shown to include a sprinkler zone controller interface 444 having inputs or outputs (“I/Os”) 450, 452. Sprinkler zone controller interface 444 can be a wired interface or a wireless interface. In an exemplary embodiment sprinkler zone controller interface 444 is a low voltage wired interface configured to send signals over, e.g., twisted pair copper wires, for reception by the sprinkler zone controller. In other embodiments sprinkler zone controller interface 444 is a high speed wired port or jack interface (e.g., an Ethernet interface). The speed and capability of sprinkler zone controller interface 444 may vary with the intended feature set of the connected zone controllers. For example, in embodiments where sprinkler zone controllers 406, 408 are configured for frequent bi-directional communication with sprinkler system master controller 404 or if sprinkler zone controllers 406, 408 include sensors for sending sensor information back to sprinkler system master controller 404 in an asynchronous manner, then sprinkler zone controller interface 444 may be configured for robust full-duplex communications. In embodiments where sprinkler zone controller 406 provides little to no feedback to sprinkler system master controller 404 and the command set for sprinkler zone controller 406 is relatively small (e.g., “on” and “off”, “on for 30 minutes”, etc.) then sprinkler zone controller interface 444 may be less robust. In some embodiments one or more sprinkler zone controllers 406 may be provided commands via a wired connection to sprinkler zone controller interface 444 while other sprinkler zone controllers (e.g., sprinkler zone controller 408) are provided commands via a wireless connection provided by radio frequency transceiver 442.

Referring still to FIG. 4B, sprinkler system master controller 404 is shown to include a sprinkler system control circuit 430. Sprinkler system control circuit 430 includes a processor 432, a zone command logic module 434, a memory 436, a sensor 438, a web service 446, and zone logs 448. Sprinkler system control circuit 430 is in communication with sprinkler zone controller interface 444 and wireless controller 440. Sprinkler system master controller 404 may be configured to “serve” web-based user interfaces to devices in communication with sprinkler system master controller 404 (e.g., in communication via radio frequency transceiver 442). For example web service 446 may be configured to open a communications port and to listen for web requests for access to sprinkler system master controller 404. In response to the requests, web service 446 is configured to provide user interfaces. The user interfaces may include zone maps that allow users to add zones together, to divide zones apart (assuming adequate control valves), to assign different schedules for each zone, to assign varying thresholds for turning the sprinkler zone “on”, and the like. The user interfaces provided by web service 446 may be similar to those shown in application Ser. No. 12/550,270, filed Aug. 28, 2009, the entirety of which is incorporated by reference. However, rather than showing lighting fixtures and lighting settings, the user interfaces would be changed to illustrate sprinkler nodes. User inputs received at a user interface generated by web service 446 may, for example, provide logic parameters for zone command logic module 434. Zone command logic module 434 generates commands for providing to wireless controller 440 or sprinkler zone controller interface 444. The commands may be generated depending one or more sprinkler command algorithms embodied within a memory device (e.g., as computer code) of logic module 434. A plurality of sprinkler command algorithms may exist within zone command logic module 434 or in memory 436. A user may select one or more of the plurality of sprinkler command algorithms for different zones of the sprinkler system via a user interface provided by web service 446. For example, a user may be presented a list using web service 446 that includes “Zone Operation via Schedule,” and “Zone Operation via ‘Smart Grow’,” among other possible list items. The user may select “Zone Operation via Schedule” for a first zone (e.g., the zone controlled by sprinkler zone controller 406) and “Zone Operation via ‘Smart Grow’” for a second zone (e.g., the zone controlled by sprinkler zone controller 408). “Zone Operation via Schedule” may turn the sprinklers of a zone on or off at the same time each day, subject to overrides or other conditions (e.g., detected motion in the zone). “Zone Operation via ‘Smart Grow’” may only provide an amount of watering that is estimated to be beneficial for the plants of a zone and may operate by tracking the number of watering days and naturally rainy days for the zone via one or more zone logs 448 stored in memory. At a regular interval that may be driven by a clock of sprinkler system control circuit 430, zone command logic module 434 determines which zone algorithms are active and checks for the user or system-established conditions for each zone algorithm. This activity may include polling sensor 438 for the most recent reading, recalling information from zone logs 448, or recalling other information from memory 436. Processor 432 may be configured to provide master control activities relative to the other modules of sprinkler system control circuit 430, wireless controller 440, and sprinkler zone controller interface 444.

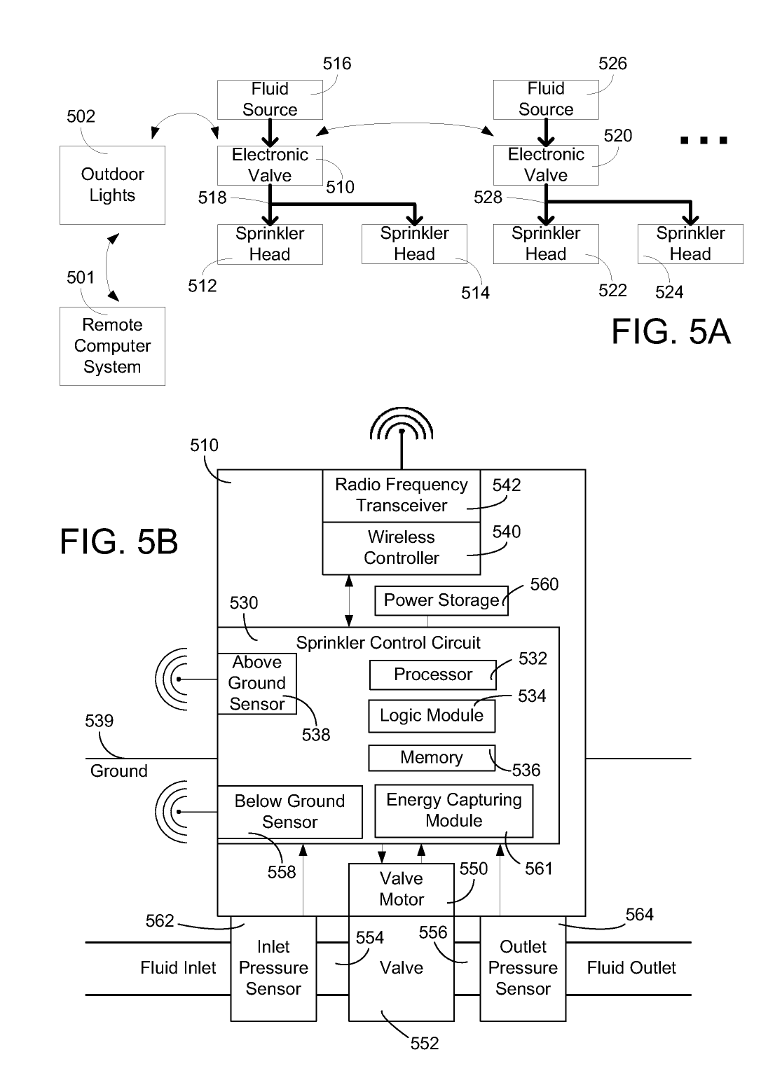

Referring now to FIG. 5A, a diagram of a sprinkler system having wirelessly controllable electronic valves 510, 520 is shown, according to an exemplary embodiment. Relative to FIGS. 4A and 3B, neither a sprinkler zone controller nor a sprinkler system master controller is used to control sprinkler zone operation. Rather, electronic valves 510 and 520 include or are closely coupled (e.g., hardwired, rigidly coupled, etc.) to control circuits including radio frequency transceivers for communicating with a remote computer system 501 via wireless communications. In the diagram of FIG. 5A, remote computer system 501 can provide sprinkler commands to outdoor lights 502 via wired or wireless data communications. In FIG. 5A, outdoor lights 502 are providing sprinkler commands to electronic valve 510. Because electronic valve 520 is outside the transmission range of outdoor lights 502, sprinkler commands intended for (e.g., addressed for) electronic valve 520 are relayed to electronic valve 520 by radio frequency transmissions of electronic valve 510.

With reference to FIGS. 5A and 5B, electronic valve 510 includes a radio frequency transceiver 542 and a sprinkler control circuit 530. Sprinkler commands received at radio frequency transceiver 542 are interpreted by wireless controller 540 or sprinkler control circuit 530. Sprinkler control circuit 530 is configured to determine if a sprinkler command represents a state change request or command for the valve. If sprinkler control circuit 530 determines that the sprinkler command represents a state change request or command for the valve, then sprinkler control circuit 530 provides an appropriate control signal to valve motor 550 which controllably actuates valve 552. Valve 552 either allows or denies fluid to flow from fluid inlet 554 and more generally fluid source 516 to fluid outlet 556, hydraulics network 518, and eventually sprinkler heads 512, 514. Electronic valve 520 may be configured the same as electronic valve 510 to controllably allow or deny fluid flow from fluid source 526 to hydraulics network 528 and sprinkler heads 522, 524. Hydraulics network 518 including electronic valve 510 and downstream sprinkler heads 512, 514 may be associated with a first zone identifier while hydraulics network 528 including electronic valve 520 and sprinkler heads 522, 524 may be associated with a second zone identifier. As described with reference to other Figures, remote computer system 501 may generate sprinkler commands including particular zone identifiers to provide discrete control capability to a plurality of different sprinkler zones. User interfaces of remote computer system 501 may be configured to provide zone maps, zone configuration tools, separate zone schedules, and the like for allowing user configurability of the logic for each sprinkler zone.

Referring further to FIG. 5B, sprinkler control circuit 530 is shown to include processor 532, logic module 534, and memory 536. Sprinkler control circuit 530 is further shown to include above ground sensor 538 and below ground sensor 558. Above ground sensor 538 may be a light sensor, a rain sensor, a motion sensor, or any other type of sensor that provides sprinkler control circuit 530 with signals regarding the environmental conditions near electronic valve 510. Below ground sensor 558 is configured to be at least partially below the ground 539 to provide sprinkler control circuit 530 with signals regarding the environmental conditions below ground 539. Below ground sensor 558 may be, for example, a moisture sensor or a temperature sensor. As shown in FIG. 5B, a portion of electronic valve 510 is positioned underground. In other exemplary embodiments the electronic valve 510 is entirely underground or not underground at all. In embodiments where electronic valve 510 is not underground at all, below ground sensor 558 may be buried underground and connected to sprinkler control circuit 530 via wires or via a low power radio frequency transceiver (e.g., compatible with radio frequency transceiver 542 or compatible with a second radio frequency transceiver of electronic valve 510). Logic module 534 may include user selectable and configurable (e.g., via a graphical user interface at remote computer system 501) control algorithms that use signals from above ground sensor 538 or below ground sensor 558 in sprinkling control activity. For example, logic module 534 may include a “need”-based sprinkler control algorithm that measures the moisture in the surrounding soil to determine if sprinkling is needed. Such an algorithm can use thresholds established by a user via a user interface or may correspond to a lawn or plant profile selected by a user. For example, a first type of grass may need to be watered less often than a second type of grass. A graphical user interface at the remote computer system 501 may allow a user to associate each zone with a particular type of grass. The different types of grass may be associated (e.g., within memory 536 with different target moisture thresholds). Sprinkler control circuit 530 can be configured to control the sprinkling frequency and duration based on the sensed moisture level relative to the thresholds. Further, if it is raining outside (as detected by above ground sensor 538), regardless of the moisture detected by below ground sensor 558, sprinkler control circuit 530 can determine that it should refrain from sprinkling to save water or to avoid a standing water situation as both the rain and the sprinkling water accumulate. Processor 532 may be configured to command or supervise the control activity provided by logic module 534. For example, processor 532 may be configured to recall computer code for the selected algorithm or plant type from memory 536 in response to receiving selection information via radio frequency transceiver 542. Processor 532 may load the relevant computer code into logic module 534 for operation. Yet further, logic module 534 may include a sprinkler control algorithm that utilizes pressure information from inlet pressure sensor 562 or outlet pressure sensor 564 in its control algorithm for operating valve motor 550 and valve 552. For example, in embodiments where valve 552 can be opened to a variety of different positions sprinkler control circuit 530 can be configured to controllably open the valve 552 using valve motor 550 such that outlet pressure sensor 564 sees a certain outlet pressure or to meter water such that water is conserved rather than wasted. Yet further, readings from inlet pressure sensor 562, outlet pressure sensor 564, above ground sensor 538, and below ground sensor 558 may be provided from the sensors to sprinkler control circuit 530 and from the sprinkler control circuit 530 to wireless controller 540 for transmission to another device (e.g., back to remote computer system 501 via outdoor lights 502) via radio frequency transceiver 542.

Referring still to FIG. 5B, electronic valve 510 is shown to include a power storage element 560 and sprinkler control circuit 530 is shown to include an energy capturing module 561. In other embodiments of electronic valve 510, a power supply wired to mains or another external power source may be included with electronic valve 510. Power storage 560 may be used as a backup power supply for electronic valve 510 or as the primary power supply for electronic valve 510. In the embodiment shown in FIG. 5B, energy capturing module 561 captures energy from a power generating device on electronic valve 510 and provides the captured energy to power storage 560 for later use by sprinkler control circuit 530, wireless controller 540, radio frequency transceiver 542, sensors 538, 558, 562, 564, or valve motor 550. Energy capturing module 561 may be a part of inlet pressure sensor 562, outlet pressure sensor 564, or valve motor 550 and may be configured to controllably “bleed” energy from the hydraulic system to generate electrical energy. For example, inlet pressure sensor 562 may be a piezoelectric sensor. Outlet pressure sensor 564 may be a small hydraulic turbine-based sensor. In such configurations, sensors 562, 564 may be used not only for sensing, but also for providing power to power storage 560 throughout the day. In order to further conserve energy, valve 510 may “power-up” only once per hour for communicating via the radio frequency transceiver to receive new sprinkler commands from a remote source or to send sensor readings and other information back to a remote computer system (e.g., remote computer system 501). In other embodiments sprinkler control circuit 530 will remain dormant during the day or night, with radio frequency transceiver 542 inactive, then power-up to transmit updated sensor readings and to check-in with the remote computer system (e.g., to obtain scheduling changes, to obtain control logic changes, to request an updated sprinkler command, etc.). Energy capturing module 561 can control the energy gathering, power-storage, and intermittent power-up activities described above. In other embodiments devices other than sensors 562, 564 are used for gathering energy. For example, one or more solar cells may be coupled to the electronic valve 510. Further, energy capturing module 561 may be a thermoelectric generator that converts heat energy into electricity. The thermoelectric generator can use, for example, a probe coupled to a metal cold water conduit of the hydraulic system and a probe coupled to a solar-catching membrane to harvest energy from the temperature gradient between the cold probe and the hot probe. In yet other embodiments a separate hydroelectric generator (e.g., a small turbine powering a generator) may be used to bleed hydroelectric energy from the hydraulic system. Hydroelectric generation may occur during the sprinkling activity or may occur during a different time (e.g., bleeding a small amount of fluid and sending the fluid to a reservoir for later use in watering rather than sending the fluid to the sprinkler heads, etc.).

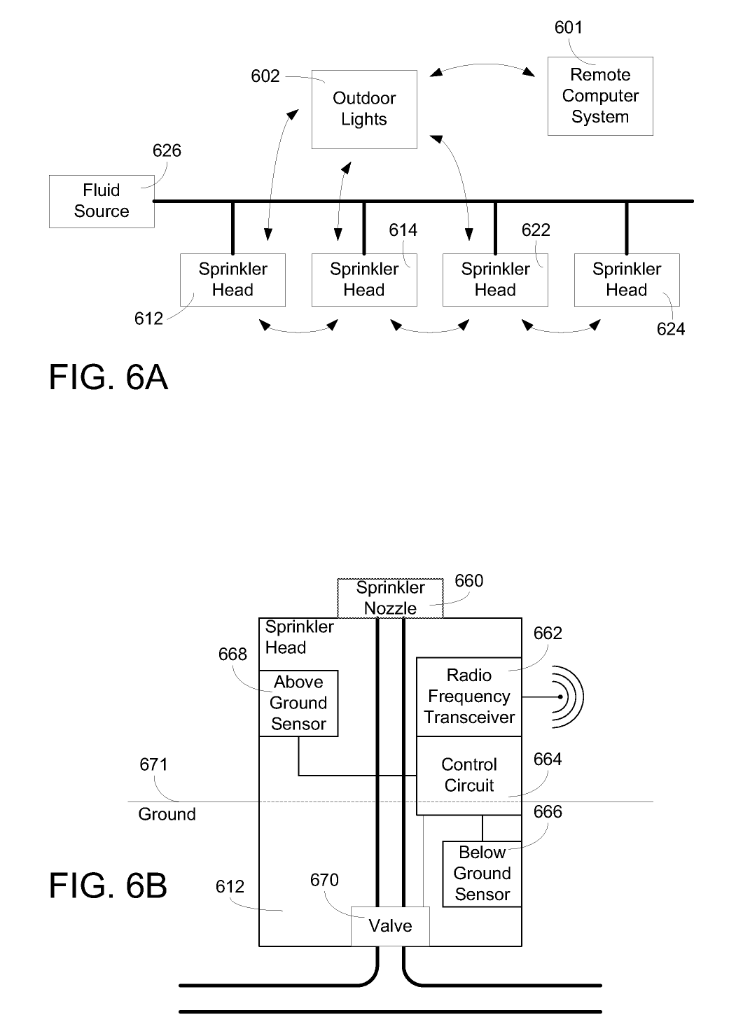

Referring now to FIGS. 6A and 6B, an embodiment is shown wherein each sprinkler head 612, 614, 622, 624 includes a radio frequency transceiver. Sprinkler heads 612, 614, 622, 624 can communicate via, for example, meshed networking to relay sprinkler commands, sensor information, or other data communications from sprinkler head to sprinkler head and back to remote computer system 601 via a network including, for example, outdoor lights 602. Such sprinkler heads, as illustrated by sprinkler head 612 in FIG. 6B, includes a valve 670 of its own configured to start or stop the flow of fluid provided to sprinkler nozzle 660. A portion of sprinkler head 612 is shown as buried beneath ground 671. A below ground sensor 666 (e.g., a moisture sensor) is configured to provide information to control circuit 664. Control circuit 664 may cause radio frequency transceiver 662 to transmit information (e.g., sensor information relating to the moisture of the ground) to a remote computer system 601 for processing. Such a system may advantageously allow for a high degree of granularity with respect to location-specific watering. Applicant envisions such an approach to be particularly beneficial for, e.g., golf courses, gardens having a variety of different plant types, or for other applications where it is desirable to create a highly uniform look to the plants and grass. Above-ground sensor 668 may be as described with reference to previous Figures, e.g., a light sensor, a motion sensor, or another sensor configured to sense environmental conditions existing in the outdoor area near sprinkler head 612. Control circuit 664 may be configured similarly to the control circuit shown and described with reference to FIG. 5B. In other embodiments control circuit 664 may be configured differently. Sprinkler head 612 may be configured to include the energy capturing modules and power storage modules mentioned with respect to FIG. 5B. Further, that water runs through sprinkler head 612 during sprinkling action may also be utilized for energy capturing. Movement (e.g., spinning) of sprinkler nozzle 660 may be used, for example, to convert kinetic energy into electric energy. For example, movement of sprinkler nozzle 660 may cause a magnet to move relative to an electromagnetic generator contained in the sprinkler head to generate electric energy for storage.

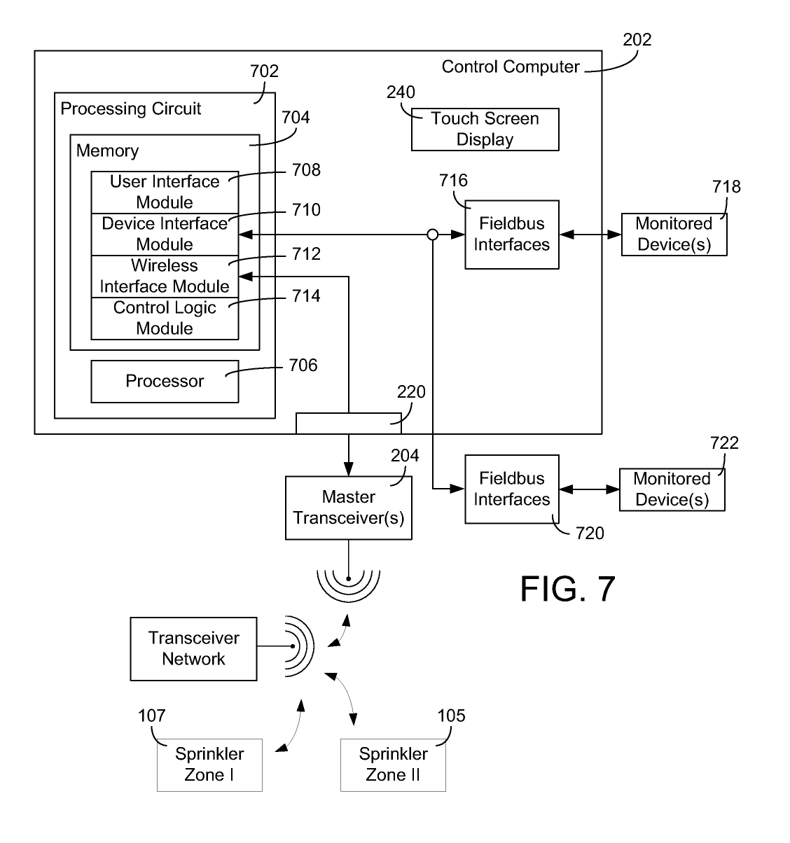

Referring now to FIG. 7, a more detailed block diagram of control computer 202 is shown, according to an exemplary embodiment. Control computer 202 may be configured as the “master controller” described in U.S. application Ser. No. 12/240,805, filed Sep. 29, 2008, and incorporated herein by reference in its entirety. Control computer 202 is generally configured to receive user inputs (e.g., via touchscreen display 240) and to set or change settings of the sprinkler system based on the user inputs.

Referring further to FIG. 7, control computer 202 is shown to include processing circuit 702 including memory 704 and processor 706. In an exemplary embodiment, control computer 202 and more particularly processing circuit 702 are configured to run a Microsoft Windows Operating System (e.g., XP, Vista, etc.) and are configured to include a software suite configured to provide the features described herein. The software suite may include a variety of modules (e.g., modules 708-714) configured to complete various activities of control computer 202. Modules 708-714 may be or include computer code, analog circuitry, one or more integrated circuits, or another collection of logic circuitry. In various exemplary embodiments, processor 706 may be a general purpose processor, a specific purpose processor, a programmable logic controller (PLC), a field programmable gate array, a combination thereof, or otherwise and configured to complete, cause the completion of, and/or facilitate the completion of the activities of control computer 202 described herein. Memory 704 may be configured to store historical data received from sprinkler zone controllers or other facility devices, configuration information, schedule information, setting information, zone information, or other temporary or archived information. Memory 704 may also be configured to store computer code for execution by processor 706. When executed, such computer code (e.g., stored in memory 704 or otherwise, script code, object code, etc.) configures processing circuit 702, processor 706 or more generally control computer 202 for the activities described herein.

Touch screen display 240 and more particularly user interface module 708 are configured to allow and facilitate user interaction (e.g., input and output) with control computer 202. It should be appreciated that in alternative embodiments of control computer 202, the display associated with control computer 202 may not be a touch screen, may be separated from the casing housing the control computer, and/or may be distributed from the control computer and connected via a network connection (e.g., Internet connection, LAN connection, WAN connection, etc.). Further, it should be appreciated that control computer 202 may be connected to a mouse, keyboard, or any other input device or devices for providing user input to control computer 202. Control computer 202 is shown to include a communications interface 220 configured to connect to a wire associated with master transceiver 204.

Communications interface 220 may be a proprietary circuit for communicating with master transceiver 204 via a proprietary communications protocol. In other embodiments, communications interface 220 may be configured to communicate with master transceiver 204 via a standard communications protocol. For example, communications interface 220 may include Ethernet communications electronics (e.g., an Ethernet card) and an appropriate port (e.g., an RJ45 port configured for CAT5 cabling) to which an Ethernet cable is run from control computer 202 to master transceiver 204. Master transceiver 204 may be as described in U.S. application Ser. Nos. 12/240,805, 12/057,217, or 11/771,317 which are each incorporated herein by reference. Communications interface 220 and more generally master transceiver 204 are controlled by logic of wireless interface module 712. Wireless interface module 712 may include drivers, control software, configuration software, or other logic configured to facilitate communications activities of control computer 202 with sprinkler zone controllers. For example, wireless interface module 712 may package, address format, or otherwise prepare messages for transmission to and reception by particular controllers or zones. Wireless interface module 712 may also interpret, route, decode, or otherwise handle communications received at master transceiver 204 and communications interface 220.

Referring still to FIG. 7, user interface module 708 may include the software and other resources for the display and handling of automatic or user inputs received at the graphical user interfaces of control computer 202. While user interface module 708 is executing and receiving user input, user interface module 708 may interpret user input and cause various other modules, algorithms, routines, or sub-processes to be called, initiated, or otherwise affected. For example, control logic module 714 and/or a plurality of control sub-processes thereof may be called by user interface module 708 upon receiving certain user input events. User interface module 708 may also be configured to include server software (e.g., web server software, remote desktop software, etc.) configured to allow remote access to the display. User interface module 708 may be configured to complete some of the control activities described herein rather than control logic module 714. In other embodiments, user interface module 708 merely drives the graphical user interfaces and handles user input/output events while control logic module 714 controls the majority of the actual control logic.

Control logic module 714 may be the primary logic module for control computer 202 and may be the main routine that calls, for example, modules 708, 710, etc. Control logic module 714 may be configured to provide sprinkler valve control, energy savings calculations, demand/response-based control, load shedding, load submetering, HVAC control, building automation control, workstation control, advertisement control, power strip control, “sleep mode” control, or any other types of control. In an exemplary embodiment, control logic module 714 operates based off of information stored in one or more databases of control computer 202 and stored in memory 704 or another memory device in communication with control computer 202. The database may be populated with information based on user input received at graphical user interfaces and control logic module 714 may continuously draw on the database information to make control decisions. For example, a user may establish any number of zones, set schedules for each zone, create sprinkler valve parameters for each zone or valve, etc. This information is stored in the database, related (e.g., via a relational database scheme, XML sets for zones or fixtures, or otherwise), and recalled by control logic module 714 as control logic module 714 proceeds through its various control algorithms.

Control logic module 714 may include any number of functions or sub-processes. For example, a scheduling sub-process of control logic module 714 may check at regular intervals to determine if an event is scheduled to take place. When events are determined to take place, the scheduling sub-process or another routine of control logic module 714 may call or otherwise use another module or routine to initiate the event. For example, if the schedule indicates that a sprinkler zone should be turned on at 5:00 pm, then when 5:00 pm arrives the scheduling sub-process may call a routine (e.g., of wireless interface module) that causes an “on” sprinkler command signal to be transmitted by master transceiver 204. Control logic module 714 may also be configured to conduct or facilitate the completion of any other process, sub-process, or process steps conducted by control computer 202 described herein.

Referring further to FIG. 7, device interface module 710 facilitates the connection of one or more field devices, sensors, or other inputs not associated with master transceiver 204. For example, fieldbus interfaces 716, 720 may be configured to communicate with any number of monitored devices 718, 722. The communication may be according to a communications protocol which may be standard or proprietary and/or serial or parallel. Fieldbus interfaces 716, 720 can be or include circuit cards for connection to processing circuit 702, jacks or terminals for physically receiving connectors from wires coupling monitored devices 718, 722, logic circuitry or software for translating communications between processing circuit 702 and monitored devices 718, 722, or otherwise. In an exemplary embodiment, device interface module 710 handles and interprets data input from the monitored devices and controls the output activities of fieldbus interfaces 716, 720 to monitored devices 718, 722.

Fieldbus interfaces 716, 720 and device interface module 710 may also be used in concert with user interface module 708 and control logic module 714 to provide control to the monitored devices 718, 722. User interface module 708 may allow schedules and conditions to be established for each of devices 718, 722 so that control computer 202 may be used as a comprehensive energy management system for a facility. For example, in addition to sprinkler system activities, control computer 202 may be configured to control lighting activities or other activities as described in application Ser. No. 12/550,270, filed Aug. 28, 2009.

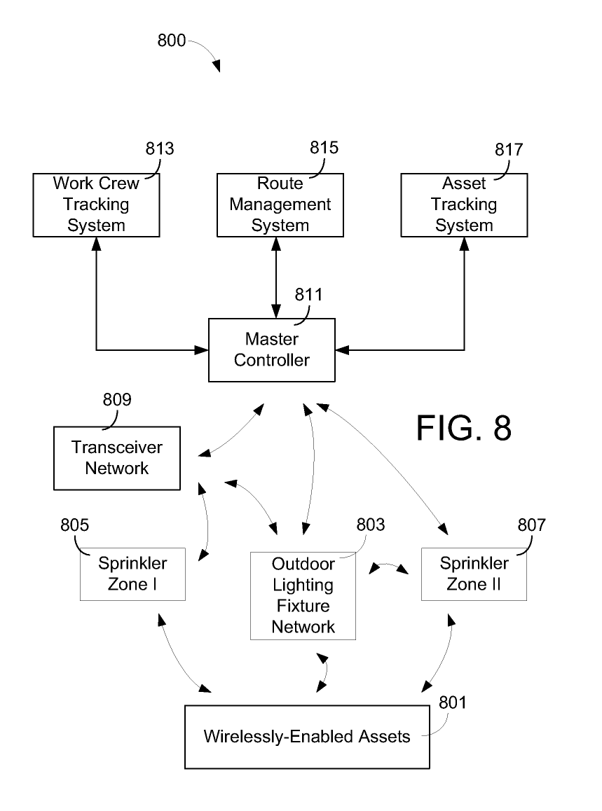

FIG. 8 is a block diagram of a system 800 for managing wirelessly-enabled assets 801, according to an exemplary embodiment. System 800 is shown to include a network of RF devices or nodes including nodes in a first sprinkler zone 805, nodes in a second sprinkler zone 807, nodes of an outdoor lighting fixture network 803, and nodes of a transceiver network 809. The nodes of zones 805, 807 and networks 803, 809 are geographically distributed. Some or all of the nodes are associated with geographic locations (e.g., certain municipal parks, different locations of a campus, certain streets, regions of parks, certain addresses, certain x,y coordinates, certain GPS coordinates, certain latitude/longitude coordinates, etc.). When wirelessly-enabled assets 801 are moving through or near the nodes of zones 805, 807 and networks 803, 809, such nodes may be configured to receive unique identifiers associated with the wirelessly-enabled assets 801. The associations between nodes and asset identifiers are processed with node geolocation information to provide asset tracking or management features for wirelessly-enabled assets 801.

Based on processing of asset identifiers and geolocation information, for example, a work crew tracking system 813 may generate a map showing the location of one or more work crews. The map may be printed via a printer forming a part of work crew tracking system 813, caused to be displayed on an electronic display, e-mailed, or otherwise physically reproduced for viewing by a human (e.g., a work crew manager). Work crew tracking system 813 may also generate detailed reports regarding work crew activity. For example, if a work crew is identified by a sprinkler zone at a first location at 1:00 pm and is still reporting work crew identifiers to the sprinkler zone at the first location at 5:00 pm, the work crew tracking system 813 may generate a report that indicates the work crew was properly at the first location from 1:00 pm through 5:00 pm.

Master controller 811 is configured to gather information about wirelessly-enabled assets 801 from zones 805, 807 or networks 803, 809. The information gathered by master controller 811 is provided to management and tracking systems 813-817. Master controller 811 may be a single electronic device or a distributed collection of computer devices. The gathering of information conducted by master controller 811 may be active or passive. If the information gathering by master controller 811 is active, the master controller 811 will poll nodes of zones 805, 807, or networks 803, 809 for information about wirelessly-enabled assets 801. If the information gathering by master controller 811 is passive, the master controller 811 will compile or track information as it is transmitted to master controller 811 by the zone or network nodes.

Wirelessly-enabled assets 801 may be mobile phones, personal digital assistants, vehicle control systems, RFID tags, or any other mobile electronic devices that may be carried or moved with assets (e.g., workers, fleet vehicles, equipment, etc.). In some exemplary embodiments, the nodes of zones 805, 807 or networks 803, 809 can include more than one receiver or transceiver for conducting wireless communications. Sprinkler nodes may communicate with each other and with lighting devices according to a first wireless protocol and with a first set of wireless communications electronics. The sprinkler nodes or the lighting devices may communicate with the wirelessly-enabled assets 801 according to a second wireless protocol and a second set of wireless communications electronics. In other embodiments, the sprinkler nodes or lighting nodes of zones 805, 807 or networks 803, 809 only include a single transceiver that is configured for communication with other nodes and for communication with wirelessly-enabled assets 801.

When a node in zones 805, 807 or networks 803, 809 receives an identifier from a wirelessly-enabled asset 801, the node can use processing circuitry to temporarily store the identifier in a memory device. Then, at a regular interval, a random interval, a pseudo-random interval, in response to a request or otherwise, the nodes can report the identifiers, time, and/or location information to master controller 811. Location information for each node may be stored in master controller 811 or in one or more of systems 813-817. In such embodiments or in other embodiments, location information for each node may be stored in the node itself In one set of exemplary embodiments, each node includes location processing circuitry (e.g., a GPS receiver and accompanying electronics) for periodically determining its own position. In another exemplary embodiment, the position of each node is human-entered and stored in memory (e.g., of the node, of the master controller, of a tracking or management system, etc.). If more than one distributed node is able to connect to a wirelessly-enabled asset during any given time period, the master controller or a tracking or management system is configured to use triangulation or other position-estimating procedures to estimate the real position of the wirelessly-enabled asset.

As explained above, the work crew tracking system 813 is configured to calculate and display location, time of arrival, time of departure, and other work-crew related information. The route management system 815 is configured to calculate and display (e.g., plot) historical routes for wirelessly-enabled assets or best routes for future travel based on historical travel times or other historical data. The asset tracking system 817 is configured to display location, time of arrival, time of departure, inventory, or other information relating to asset properties.

Referring generally to FIG. 8, the networks of distributed sprinkler nodes and/or lighting nodes described throughout this disclosure may be used to help track assets moving through or around locations associated with said networks. A controller for receiving and processing information about wirelessly-enabled assets is included in a system for managing the assets. The controller provides results of such receptions and processing to systems for tracking or managing varying types of assets. The tracking or management systems can generate and display graphical user interfaces or reports via coupled electronic displays or printers.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A sprinkler control system, comprising:
an outdoor light comprising a control circuit and a first radio frequency transceiver; and
a sprinkler zone controller comprising a second radio frequency transceiver and electronics for controlling at least one flow control device of the sprinkler zone;
wherein the control circuit for the outdoor light is configured to provide a control signal to the sprinkler zone controller via the first radio frequency transceiver and the second radio frequency transceiver.

2. The system of claim 1, wherein the control circuit of the outdoor light is configured to identify sprinkler information in data received at the first radio frequency transceiver and is configured to retransmit the identified sprinkler information via the first radio frequency transceiver as the control signal.

3. The system of claim 1, wherein the sprinkler zone controller is configured to retransmit the control signal for other sprinkler controllers in response to receiving the control signal at the second radio frequency transceiver.

4. The system of claim 1, wherein the first and second radio frequency transceivers are configured for wireless mesh networking with additional radio frequency transceivers.

5. The system of claim 1, wherein the sprinkler zone controller includes an environment sensor configured to sense a condition of an outdoor area associated with the sprinkler zone controller.

6. The system of claim 5, wherein the flow control device is one of a hydraulic valve and a pump, wherein the sprinkler zone controller comprises a logic module configured to determine whether the sprinkler zone controller should cause the flow control device to change states based on the condition sensed by the environment sensor.

7. The system of claim 6, wherein the logic module is configured to cause the second radio frequency transceiver to transmit information representative of the sensed condition to the first radio frequency transceiver for routing to a master controller for the sprinkler control system.

8. The system of claim 7, wherein the logic module is further configured to cause the second radio frequency transceiver to transmit the information representative of the sensed condition to another sprinkler zone controller for action.

9. A sprinkler system, comprising:
a plurality of electronically controlled valves;
a control circuit coupled to each of the plurality of electronically controlled valves, each control circuit including a transceiver for sending and receiving data communications; and
a master controller configured to cause the plurality of electronically controlled valves to controllably actuate by transmitting a command to at least one of the plurality of electronically controlled valves.

10. The sprinkler system of claim 9, further comprising:
an outdoor lighting fixture having a radio frequency transceiver configured to route communications from the master controller to the transceivers of the control circuits for the plurality of electronically controlled valves.

11. The sprinkler system of claim 10, further comprising an environment sensor configured to sense a condition of an outdoor area associated with the control circuit.

12. The sprinkler system of claim 11, wherein the electronically controlled valves comprise a hydraulic valve, and wherein the master controller comprises a logic module configured to determine whether the master controller should cause the electronically controlled valves to change states based on the condition sensed by the environment sensor.

13. A sprinkler head, comprising:
an electronically controllable valve configured to cause the sprinkler head to controllably release and restrain fluid flow;
a radio frequency transceiver configured to receive a command from a remote source and to provide the command to the control circuit; and
a control circuit configured to provide a signal to the electronically controllable valve in response to the command.

14. The sprinkler head of claim 13, further comprising:
a sensor configured to sense an environment condition and to provide a signal representative of the environment condition to the radio frequency transceiver for transmission to at least one of other sprinkler heads and a master controller.

15. The sprinkler head of claim 14, wherein the command from the first remote source is a command to begin sprinkling and wherein the control circuit is configured to interpret the command to determine whether to provide the signal to the electronically controllable valve in response to the command, wherein the signal is configured to actuate the valve to begin the flow of fluid through the sprinkler head.

16. The sprinkler head of claim 13, wherein the control circuit is configured to cause the radio frequency transceiver to broadcast an indication of the sprinkler head's operational status for reception by the remote source.
